(19) United States
(12) Patent Application Publication
(10) Pub. No.: US 2006/0256194 A1
(43) Pub. Date: Nov. 16, 2006

(54) Parallel confocal laser microscopy system based on vcsel technology

(76) Inventors: Bertrand Viellerobe, Nogent Sur Marne (FR); Frederic Berier, Courbevoie (FR); Jean-Michel Boniface, Le Bretonneux (FR)

Correspondence Address: YOUNG & THOMPSON, 745 SOUTH 23RD STREET, 2ND FLOOR, ARLINGTON, VA, 22202, US

(21) Appl. No.: 10/539,572

(22) PCT Filed: Dec. 12, 2003
(86) PCT No.: PCT/FR03/03687

§ 371 Date: Jun. 17, 2005

(30) Foreign Application Priority Data
Dec. 20, 2002 (FR) 02/16276

(51) Int. Cl. H04N 7/18

(52) U.S. Cl. 348/78

(57) ABSTRACT

A parallel confocal laser microscopy system (2) includes a VCSEL vertical cavity laser array (23) for emitting light beams, optical elements (24) for focusing the light beams onto an object (25) to be observed. The invention is characterized in that a photodetector (22) is arranged behind each VCSEL laser such that the photodetector is capable of receiving a light beam backscattered from the object (25) via the VCSEL laser cavity, the cavity having an opening acting as filtering hole.

The present invention relates to a system and a method of parallel confocal laser microscopy. It is used in particular, but not exclusively, in the field of medical imagery.

Generally, the principle of confocal microscopy is based on the illumination of a specimen by a point light source and by the detection of the photons returning from this specimen through a filtering hole conjugate with an excitation plane, this allowing in particular a light section to be obtained.

The document “Parallel confocal laser microscope system using pixel arrays” by Makoto Naruse et al.; Proceedings of SPIE, Vol. 4092, pp. 94-101 (on Internet:“http: //www.k2.u-tokyo.ac.jp/papers/optics/ conf/naruse_confocal_SPIE00.pdf”) is known, in which the author describes a system 1 of parallel confocal microscopy in accordance with FIG. 1. An array 10 of lasers is shown of VCSEL type (“Vertical-cavity surface-emitting laser”) emitting a light beam towards a specimen 13 placed on a plate 14. This incident beam firstly passes through a semi-transparent mirror 11 then an optical system 12 to focus the beam onto the specimen 13. The mirror 11 allows the light beam back-scattered by the specimen 13 to be deviated towards an array of photodetectors 16. In order to respect the notion of confocality, filtering holes 15 are arranged upstream of the photodetectors 16. A control unit 18 receives the signals generated by the photodetectors using a processing device 17 so as to control the array of lasers 10, the plate 14 and the optical system 12.

However, such a system is not optimized in terms of space requirement.

Moreover, document WO 0025165 (CNRS; Gorecki et al.) is known in which an electronic component is described comprising a photodetector mounted on a VCSEL laser for the reception of a back-scattered beam originating from a specimen. This component also comprises a tip for the emission and the reception of the light beams. However, this document only relates to microscopy in the near field without an optical system to focus the light beams.

The purpose of the present invention is a miniature confocal microscopy system.

Another purpose of the invention is to propose a microscopy system allowing images to be acquired in real time.

The purpose of the invention is also to allow laser scanning for the acquisition of good quality images.

At least one of the aforementioned objectives is achieved with a parallel confocal laser microscopy system comprising in particular:
an array of vertical-cavity surface-emitting lasers (VCSEL) for emitting light beams,
optical means for focusing the light beams onto an object to be observed.

According to the invention, a photodetector is arranged on one face of each VCSEL laser such that this photodetector is capable of receiving a light beam originating from the object via the VCSEL laser cavity, this cavity having an opening used as a filtering hole.

The invention is in particular remarkable because a virtual point laser source is used the cavity opening of which serves as a filtering hole. The cavity opening of the VCSEL laser advantageously has a diameter of a few microns.

Preferably, the photodetector is arranged on a face opposite to the cavity opening of the VCSEL laser. Contrary to the system of FIG. 1 of the prior art, the laser source and the photodetector are aligned with the optical axis, the laser beam axis. These two elements can be integrated in the same device, which allows the space requirement of the system to be considerably reduced. The system can thus consist of a miniature head in the form of a housing. Therefore applications can be envisaged such as endoscopy for which the miniature head is arranged at the end of an endoscope. By way of example, the external diameter of the miniature head can be comprised between 2 and 10 mm, for a length of between 10 and 30 mm.

As regards endoscopy, two implementation methods can be envisaged. A first method in which the miniature head is removable. In this case, this miniature head and its electric wiring (supply, control signals, useful signals etc.) can be inserted in the operating channel of an endoscope, the operating channel usually serving to pass through the tools which a practitioner needs to carry out measurements or take samples. Therefore, the head is brought to the end of the endoscope so as to carry out, in particular, an optical biopsy. A second method in which the miniature head is fixed, completely integrated with the end of an endoscope.

Generally, the system according to the invention can be used during the backscattering applications.

Advantageously, the system can moreover comprise scanning means for carrying out laser scanning so as to produce an image.

The array makes it possible, in particular, to work with a large amount of data at the same time, thus improving the quality of the image obtained. In fact, it is possible to remain longer on each point and to integrate for longer. The useful signal then contains enough information to allow quality processing. Several points are acquired at the same time whilst preserving the confocality, the latter being ensured by the virtual point source assembly (spatial filtering) and optical system. The criterion of confocality can allow optical sections to be produced of the order of 1 to 3 microns. Thus, the choice of the VCSEL laser (useful cavity diameter and numerical aperture) and of the optical system (magnification, numerical aperture) is in particular set by the confocality.

Preferably, the system also comprises means for controlling the scanning means so as to carry out an acquisition of images in real time.

Depending on the array (parallel multi-point acquisition) and the type of scanning used, the system makes it possible to go down to low scanning frequencies such as for example 400 Hz, for which the components are extremely reliable whilst allowing an acquisition of images in real time. By real time is meant an acquisition starting from approximately ten images per second. In order to reach such performances (approximately ten images per second), prior systems required scanning frequencies over 4 kHz.

With respect to the system of the prior art (FIG. 1), the flux loss is reduced as the semi-transparent mirror disappears; the sensitivity of detection can be improved by increasing the integration time of the data since the acquisition takes place over several points at the same time; and the image line scanning frequency can be adjusted in particular downwards.

With the array according to the invention, the field of view can be sufficiently large, i.e. having a surface of at least 150 microns by 150 microns for example. The confocal character and a large enough field of view represent a real advantage in the medical field, in particular within the context of helping with the early diagnosis of cancerous lesions.

Continuous scanning makes it possible to obtain an image in which each pixel represented carries useful information originating from the specimen.

The scanning frequencies and the number of laser sources can be determined so as to carry out an image acquisition in virtual real time. In certain fields such as the medical field, real time is a necessity in order to compensate for the movement of the patient and the practitioner.

Advantageously, the scanning means can comprise MEMS (“micro-electro-mechanical system”) micro-systems and/or piezoelectric positioners, capable of moving the VCSEL laser array and/or the optical means.

A person skilled in the art will easily understand that the optical system can comprise one or more refractive and/or diffractive lenses.

According to the invention, the optical means, in particular the lenses, are capable of directing each light beam originating from the object to be observed towards the cavity of a VCSEL laser, the cavity opening then carrying out filtering.

Insofar as a photodetector is arranged to the rear of each VCSEL laser, the loss of light beams emitted to the rear of the VCSEL laser and captured by the photodetector are not negligible with respect to the useful light beam originating from the object to be observed. According to an advantageous characteristic of the invention, in order to only detect the useful light beam, means for modulating the light beams leaving the array are arranged. These means can be an acousto-optical or electro-optical modulator, or any other type of suitable modulation means. Thus, the light beams originating from the object to be observed are also modulated. Means of synchronous detection can then be arranged to extract a useful signal from the electrical signal generated by each photodetector.

Advantageously, the optical means can comprise at least one moveable lens to allow an image acquisition at different depths of the object to be observed. Therefore, three-dimensional images can be produced. Variable curvature lenses can also be used or the array can be moved axially, i.e. along the z axis, to produce an in-depth scanning.

According to another aspect of the invention, a parallel confocal laser microscopy method is proposed in which a plurality of light beams is emitted from a VCSEL vertical cavity laser array, and these light beams are focused onto an object to be observed using an optical system such as lenses for example. According to the invention, a photodetector is arranged on a face of each VCSEL laser so as to receive a light beam originating from the object on this photodetector via the VCSEL laser cavity, and the opening of this cavity is used as a filtering hole for the light beam originating from the object.

Preferably, the photodetector is arranged on the face opposite to the opening of the laser cavity.

Other advantages and characteristics of the invention will become apparent on examination of the detailed description of an embodiment which is in no way limitative, and of the attached drawings, in which:

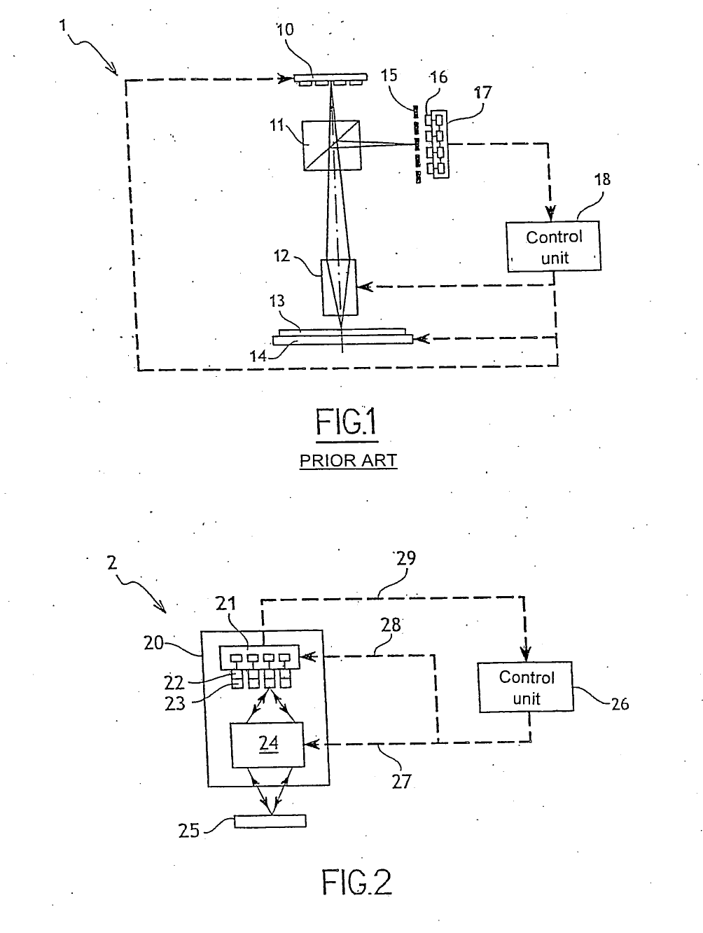

FIG. 2 is a block diagram illustrating the operation of a microscopy system according to the invention;

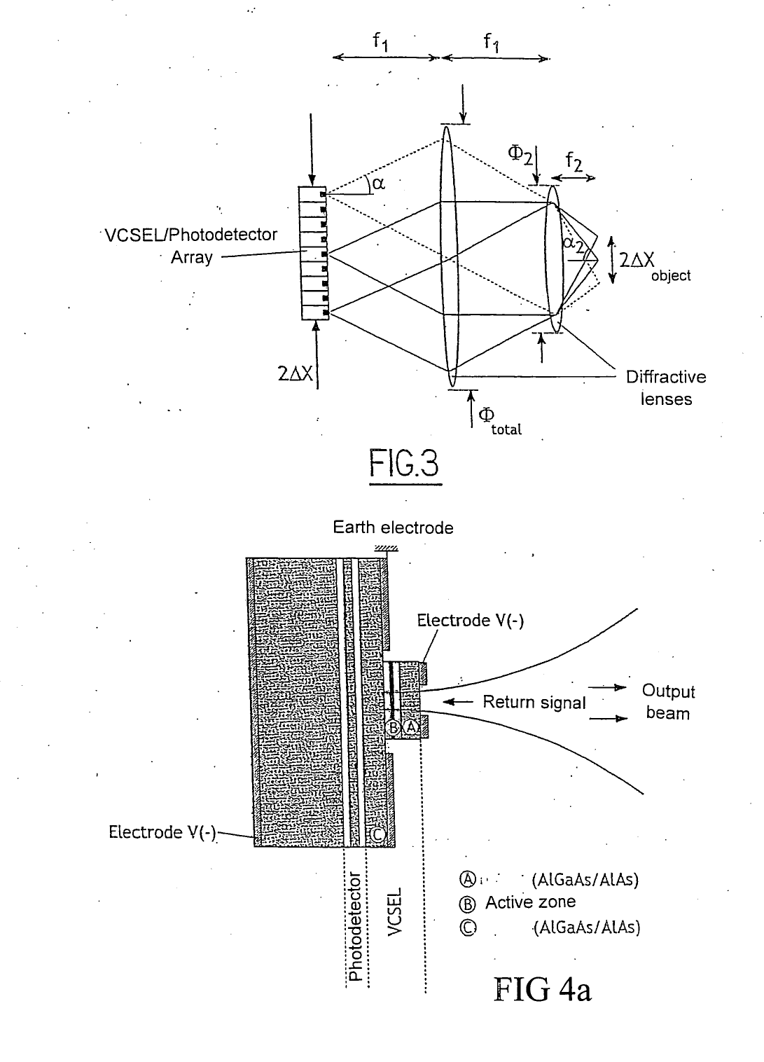

FIG. 3 is a diagram illustrating an example of the dimensioning of the main elements of a microscopy system according to the invention;

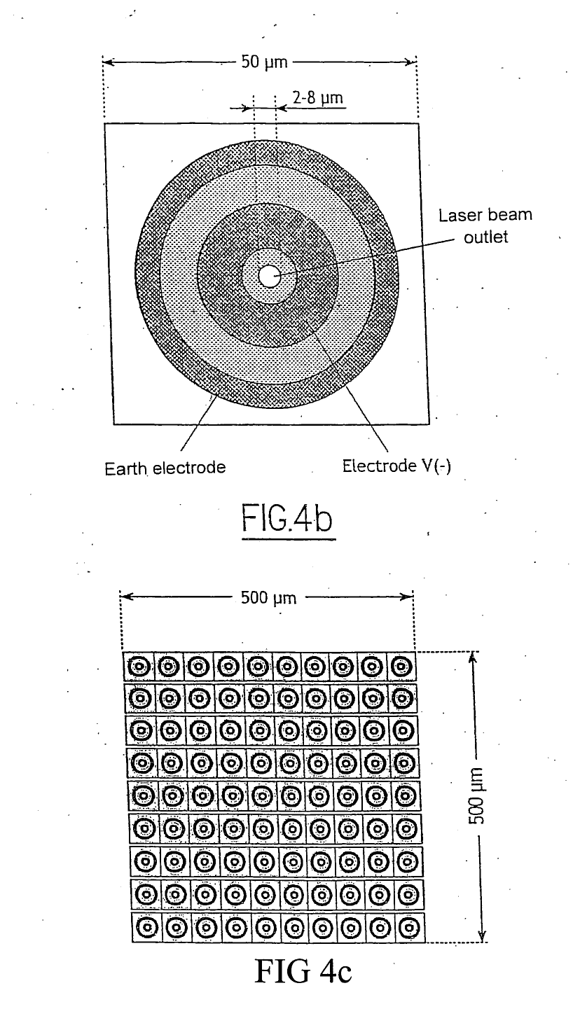

FIG. 4a is a cross section of an electronic component comprising a laser of VCSEL type produced on a photodetector;

FIG. 4b is a top view of the VCSEL laser of FIG. 4a;

FIG. 4c is a top view of a plurality of components of FIG. 4a arranged in an array;

FIG. 5 is a simplified diagram of the system according to the invention in which the laser scanning is obtained by the movement of lenses using MEMS systems; and

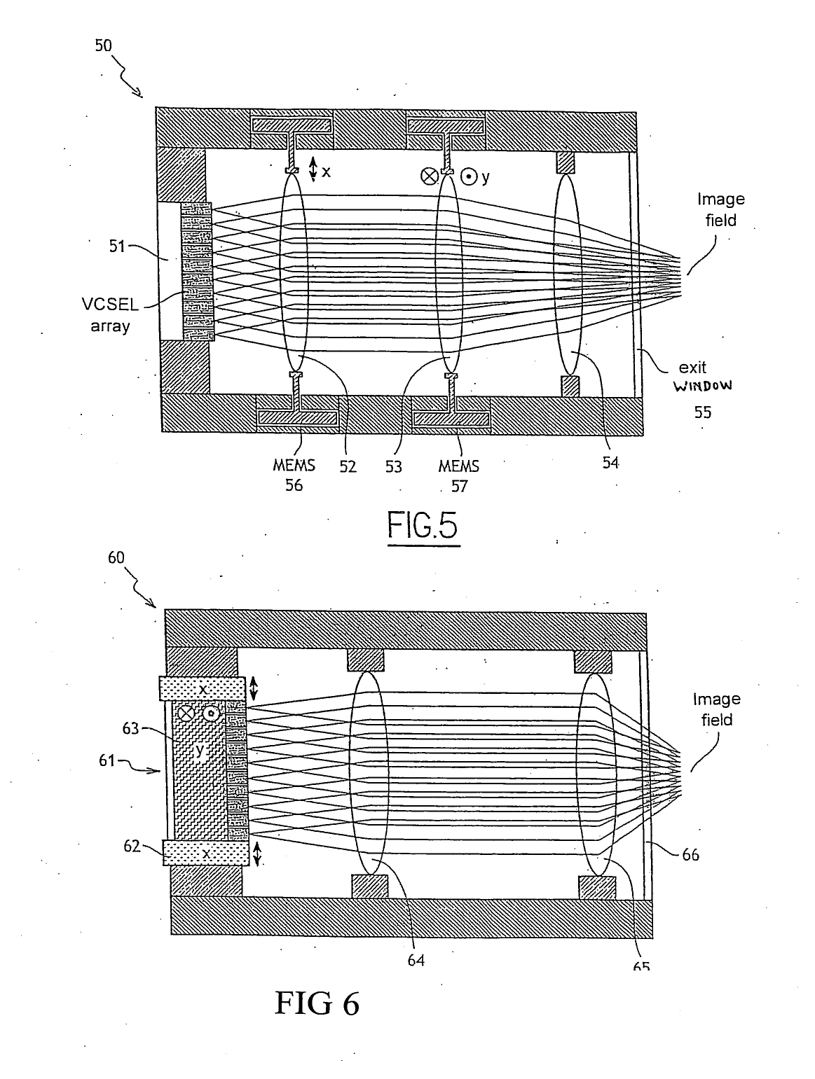

FIG. 6 is a simplified diagram of the system according to the invention in which the laser scanning is obtained by movement of the array using piezoelectric positioners.

A miniature head according to the invention will now be described using the simplified and non-limitative diagrams of FIGS. 2 to 6.

The general principle of the system according to the invention is represented in FIG. 2. In contrast to the prior art as represented in FIG. 1, the system 2 according to the invention does not contain a semi-transparent mirror. In fact, in the system according to the invention, the emitter i.e. the VCSEL laser, and the receiver i.e. the photodetector, are aligned along the axis of the light beam. Each photodetector 22 is mounted on each VCSEL laser 23.

Each VCSEL laser 23 of the array emits a monochromatic and single-mode light which is focused by an optical system 24 onto the object to be observed such as a specimen 25.

In particular VCSEL lasers are used with a wavelength comprised between 630 nanometres and 1200 nanometres. The light beam back-scattered from the specimen 25 takes the same path as the incident beam via the optical system 24, then returns into the VCSEL laser 23 passing through it until reaching the photodetector 22.

The electrical signal generated by the photodetector 22 is processed by a processing system 21 comprising, in particular, means of amplification and digitizing. The digital signal 29 is then transmitted to a control unit 26. The array, composed of the elements 22 and 23, and the optical system 24 are capable of being controlled by the control unit 26 using control signals 28 and 27 respectively. The control signals 28 can consist of commands for moving the array in two directions x and y so as to acquire two-dimensional images (as seen in FIG. 6), signals controlling the light intensity of the VCSEL lasers, signals controlling the photodetectors and signals controlling the processing means. The control signals 27 are capable of managing the movement of the optical system as seen in FIG. 5.

The array and the optical system can be integrated into a miniature head 20 arranged at the end of an endoscope.

In FIG. 3 an example of the dimensioning of a system according to the invention is represented. In this example, the optical system contains two diffractive lenses. The dimensioning parameters are the following:

Wavelength: between 680 and 880 nm;

Source field: 2ΔX=400-600 μm

Diameter of the VCSEL cavity opening: Φ_{cavity}=2-4 μm

VCSEL cavity numerical aperture: sin(α)=0.25 (in air)

Focal length first lens: f1=3 mm

Diameter first lens: Φₜₒₜₐₗ=2 mm

Focal length second lens: f2=1.17 mm

Diameter second lens: Φ2=1.6 mm

Optical system magnification: G=3

Imaged field: 2ΔX_{object}=160 μm-240 μm

Object numerical aperture=n sin(α₂)=0.75 (in water, n=1.33)

The diameter of each spot focused in the specimen is limited by the diffraction over all the field imaged.

With a system as represented in FIG. 2, in order to produce an image, laser scanning is carried out either by moving the lenses of the optical system 24 using MEMS systems as will be seen further on in FIG. 5, or by moving the array with piezoelectric positioners as will be seen in FIG. 6. The scanning frequencies are chosen as a function of the number of point sources (VCSEL laser) used simultaneously in the array. For example, for a 10 by 10 array, frequencies of 10 hertz ((frame) and 400 hertz (line) are used. These frequencies make it possible to obtain a real-time two-dimensional scanning.

The signal originating from the specimen is focused at the VCSEL laser input by taking the same optical path as the incident signal. The spatial filtering necessary to the confocality is carried out at the input/output of the VCSEL laser as the cavity opening of this laser is of the order of a few microns. The confocality is dependent on the numerical aperture and the magnification of the optical system as well as on the numerical aperture of the lasers. The signal thus filtered is then detected by the photodetector which is placed behind the laser cavity.

The amplification factor of the VCSEL laser cavity is approximately 10⁶.

Two detection modes can be envisaged such as:
Continuous mode: the VCSEL laser emits continuously. Part of this emitted light is detected by the photodetector as the Bragg mirror in the cavity on the detector side has transmission of the order of 1%. The background signal detected by the photodetector and originating from the cavity is of the order of 10⁻². On the other hand, the back-scattered signal originating from the specimen being of the order of 10⁻⁵ to 10⁻⁶, this signal is amplified by the cavity until it reaches a value comprised between 1 and 10 in the cavity. Passing through the Bragg mirror causes its value to pass between 10⁻² and 10⁻¹. The useful signal generated by the photodetector is therefore at least of the order of the background signal.
Synchronous mode: the output signal of the VCSEL laser is modulated by an acousto-optical modulator (not shown) placed in the optical system 24. The useful signal is itself therefore also modulated at the same frequency. It is then sufficient to use detection synchronous with the modulation signal in order to extract the useful signal and reject the background signal.

FIG. 4a shows in slightly more detail an electronic component according to the invention in which, starting with the same substrate, a photodetector and a VCSEL laser are produced by epitaxial growth. The photodetector is arranged on the rear face of the laser opposite to the emission face of the laser. FIG. 4b is a front view of the electronic component of FIG. 4a. It shows in particular the cavity opening of the VCSEL laser through which the light beam is emitted. For information, the diameter of this opening can be comprised between 2 and 8 micrometres whereas the electronic component can have an overall length of 50 microns. FIG. 4c is a front view of several electronic components of FIG. 4a arranged in an array. With the dimensions of FIG. 4b and by arranging the components in a 10 by 10 array, an array is obtained the side of which is equal to 500 microns, making it possible to obtain a large enough field of view.

FIG. 5 shows a miniature head according to the invention in which the laser scanning is obtained by movement of two lenses. The miniature head in FIG. 5 comprises a housing 50, at the base of which a VCSEL laser/photodetector array 51 is arranged. The lasers in the array emit along parallel axes towards the inside of the housing 50. The light beams emitted pass through three lenses 52, 53 and 54 so as to be focused on an object (not shown) outside the housing on the other side of an exit window 55 arranged on the base opposite to the base containing the array 51. The light beams all converge in an image field plane arranged in the object to be observed (not shown).

The convergence lens 54 is fixed integral with the housing 50, whereas the two lenses 52 and 54 are mobile, being fixed on MEMS micro-systems 56 and 57. The MEMS 56 allows the lens 52 to be moved in an X direction in a plane perpendicular to the laser emission axis. The MEMS 57 allows the lens 53 to be moved in a Y direction perpendicular to the laser emission axis and the X axis. These movements make it possible to carry out laser scanning in an X Y plane. Then, by processing the signal upstream of the photodetectors, the image field can be reconstructed. The scanning amplitude of MEMS micro-systems is determined so as to achieve at least 150 by 150 microns of imaged fields for example. The data processing can consist of conventional algorithms.

According to a variant or in a complementary fashion, the laser scanning can be operated by movement of the array. In order to do this, the miniature head is a housing 60, at the base of which an array 61 is arranged. Piezoelectric positioners are inserted between the lateral faces of the array and the housing 60. These piezoelectric positioners are arranged in twos on parallel sides. The positioners 62 allow movement along the X axis, and the positioners 63 allow movement of the array along the Y axis. In this case, the lenses 64 and 65 allowing the light beams to be focused can be fixed.

Then only two lenses are used instead of three as previously. The amplitude of movement of the piezoelectric positioners allows each VCSEL laser to be covered. By way of example, with the dimensions in FIGS. 4a to 4c, this amplitude is approximately 50 microns.

The laser scanning operations as represented in FIGS. 5 and 6 allow a two-dimensional image of the imaged field to be obtained. Light beam scanning can then be introduced in an axial direction in order to choose the depth of visualization in the object to be observed. Scanning in the Z direction perpendicular to the X and Y directions allows three-dimensional reconstructions of the object observed. In order to do this, different two-dimensional acquisitions are carried out at different depths and a volume is reconstructed by data processing.

More precisely, again with reference to FIGS. 5 and 6, in-depth scanning is carried out by making the lens 54 in FIG. 5, the lens 64 or the lens 65 in FIG. 6 mobile. This new mobile lens makes it possible to focus all of the scanned field laterally (two-dimensional image) at different depths in the object observed. The movement of this lens can be obtained using piezoelectric elements or MEMS micro-systems. Scanning in the Z direction can be carried out according to two modes: either by changing the depth of visualization frame by frame, the acquisitions being carried out at given depths, or by making in-depth “films”, i.e. the acquisition is carried out automatically on different successive planes before three-dimensional reconstruction.

Of course, the invention is not limited to the examples which have just been described and numerous adjustments can be made to these examples without exceeding the framework of the invention. In fact, it is possible to envisage increasing the complexity of the optical means in order to optimize the performance of the system, in particular in order to avoid any aberration faults, as a function of the application of the system.

1. Parallel confocal laser microscopy system comprising:
an array of vertical-cavity lasers (VCSEL) for emitting light beams, and
optical means for focusing the light beams onto an object to be observed.
characterized in that a photodetector is arranged on one face of each VCSEL laser such that this photodetector is capable of receiving a light beam originating from said object via the VCSEL laser cavity, this cavity having an opening used as a filtering hole.

2. System according to claim 1, characterized in that the photodetector is arranged on a face opposite to the cavity opening of the VCSEL laser.

3. System according to claim 1, characterized in that it moreover comprises scanning means for carrying out laser scanning so as to produce an image.

4. System according to claim 1, characterized in that it moreover comprises means for controlling the scanning means so as to carry out an acquisition of images in real time.

5. System according to claim 3 characterized in that the scanning means comprise MEMS micro-systems.

6. System according to claim 3, characterized in that the scanning means comprise piezoelectric positioners.

7. System according to claim 3, characterized in that the scanning means are capable of moving the VCSEL laser array.

8. System according to claim 3, characterized in that the means of scanning are capable of moving optical means.

9. System according to claim 1, characterized in that the optical means are capable of directing each light beam originating from the object to be observed towards the cavity of a VCSEL laser.

10. System according to claim 1, characterized in that it moreover comprises modulation means for modulating the light beams emitted from the array.

11. System according to claim 10 in which the light beams originating from the object to be observed are modulated, characterized in that it comprises synchronous detection means for extracting a useful signal from the electrical signal generated by each photodetector.

12. System according to claim 1, characterized in that the optical means comprise at least one mobile lens for allowing image acquisition at different depths of the object to be observed.

13. System according to claim 1, characterized in that the optical means comprise at least one variable curvature lens for allowing image acquisition at different depths of the object to be observed.

14. System according to claim 1, characterized in that it comprises means for axially moving the array so as to carry out image acquisition at different depths of the object to be observed.

15. System according to claim 1, characterized in that it consists of a miniature head in the form of a housing.

16. Application of the system according to claim 15 in which the miniature head is arranged at the end of an endoscope.

17. Method of parallel confocal laser microscopy in which a plurality of light beams are emitted from an array of VCSEL vertical cavity lasers, these light beams are focused on an object to be observed; characterized in that a photodetector is arranged on a face of each VCSEL laser so as to receive a light beam originating from the object on this photodetector via the VCSEL laser cavity, and in that the opening of this cavity is used as a filtering hole for the light beam originating from the object.

18. Method according to claim 17, characterized in that laser scanning is carried out so as to produce an image.

19. Method according to claim 17, characterized in that laser scanning is carried out so as to acquire images in real time.

20. Method according to claim 18 characterized in that the laser scanning is carried out by moving optical means used to focus the light beams.

21. Method according to claim 18, characterized in that the laser scanning is carried out by moving the array.

22. Method according to claim 18, characterized in that MEMS-type micro-systems are used for carrying out the laser scanning.

23. Method according to claim 18, characterized in that piezoelectric positioners are used for carrying out the laser scanning.

24. Method according to claim 17, characterized in that the light beams emitted from the array are modulated and synchronous detection is carried out at the level of the photodetector.
